(19) United States
(12) Patent Application Publication
(10) Pub. No.: US 2026/0225027 A1
(43) Pub. Date: Aug. 6, 2026

(54) MULTIMODAL OXYGEN CONTROL MODULE AND MULTIMODAL OXYGEN CONTROL APPARATUS

(71) Applicant: Samsung Electronics Co., Ltd., Suwon-si (KR)

(72) Inventors: Donghyo KIM, Suwon-si (KR); Hyunku JEONG, Suwon-si (KR); Bokyung LEE, Suwon-si (KR); Kisup LEE, Suwon-si (KR); Jinkook YOON, Suwon-si (KR); Namsoo PARK, Suwon-si (KR); Youngchul KO, Suwon-si (KR)

(21) Appl. No.: 19/429,956

(22) Filed: Dec. 22, 2025

Related U.S. Application Data
(63) Continuation of application No. PCT/KR2025/020766, filed on Dec. 4, 2025.

(30) Foreign Application Priority Data
Feb. 4, 2025 (KR) 10-2025-0013933

(51) Int. Cl. B01D 53/047

(52) U.S. Cl. CPC B01D 53/047; B01D 2256/12; B01D 2259/40007; B01D 2259/40054; B01D 2259/40056; B01D 2259/402

(57) ABSTRACT

A multimodal oxygen control module includes an oxygen generator configured to separate oxygen from components of air by discharging, as a second flow and a third flow, air flowing in as a first flow, an exhaust node configured to provide a diversion point for the third flow and to be in fluid communication with outside, an ozone generator into which a fourth flow diverted from the exhaust node flows, the ozone generator being configured to convert oxygen from components of incoming air into ozone and to discharge the ozone as a fifth flow, and an intake node into which the fifth flow flows, the intake node being configured to be in fluid communication with the outside and to provide the first flow to the oxygen generator, wherein an ozone component included in the fifth flow is included in the first flow and flows into the oxygen generator.

### CROSS-REFERENCE TO RELATED APPLICATIONS

This application is a continuation of International Application No. PCT/KR2025/020766designating the United States, filed on December 4, 2025, in the Korean Intellectual Property Receiving Office and claiming priority to Korean Patent Application No. 10-2025-0013933, filed on February 4, 2025, in the Korean Intellectual Property Office, the disclosures of each of which are incorporated by reference herein in their entireties.

### BACKGROUND

### Field

The disclosure relates to a multimodal oxygen control module and a multimodal oxygen control apparatus.

### Description of Related Art

Oxygen control apparatuses may increase or decrease an oxygen concentration in air of a particular environment.

An oxygen control apparatus may include an oxygen generator configured to separate oxygen from air. Long-term use of an oxygen control apparatus may degrade the oxygen separation performance of the oxygen generator.

### SUMMARY

A multimodal oxygen control module according to an example embodiment of the disclosure may include: an oxygen generator configured to separate oxygen from components of air by discharging, as a second flow and a third flow, air flowing in as a first flow; an exhaust node configured to provide a diversion point for the third flow and to be in fluid communication with outside; an ozone generator configured to receive a fourth flow diverted from the exhaust node, the ozone generator being configured to convert oxygen from components of incoming air into ozone and to discharge the ozone as a fifth flow; an intake node into which the fifth flow is configured to flow, the intake node being configured to be in fluid communication with the outside and to provide the first flow to the oxygen generator; and wherein an ozone component included in the fifth flow is included in the first flow by passing through the intake node and flow into the oxygen generator to recover the oxygen generator.

A multimodal oxygen control apparatus according to an example embodiment of the disclosure may include: an oxygen generator configured to separate oxygen from components of air by discharging, as a second flow and a third flow, air flowing in as a first flow; a chamber configured to provide the first flow to the oxygen generator, and to receive the second flow flows; a control node including a control flow path configured to draw in air from the outside or discharge air to the outside, the control node being configured to provide a diversion point for the third flow; an ozone generator configured to receive a fourth flow diverted from the control node, the ozone generator being configured to convert oxygen from components of incoming air into ozone and to discharge the ozone as a fifth flow that configured to flow into the chamber; and wherein an ozone component included in the fifth flow is included in the first flow by passing through the chamber and flow into the oxygen generator to regenerate the oxygen generator.

### BRIEF DESCRIPTION OF THE DRAWINGS

The above and other aspects, features and advantages of certain embodiments of the present disclosure will be more apparent from the following detailed description, taken in conjunction with the accompanying drawings, in which:

FIG. 1 is a diagram illustrating an example multimodal oxygen control module according to various embodiments.

FIG. 2 is a diagram illustrating a first mode of a multimodal oxygen control module according to various embodiments.

FIG. 3 is a diagram illustrating a deodorization mode of a multimodal oxygen control module according to various embodiments.

FIG. 4A is a diagram illustrating an example oxygen generator according to various embodiments.

FIG. 4B is a diagram illustrating an example oxygen generator according to various embodiments.

FIG. 4C is a diagram illustrating an example oxygen generator according to various embodiments.

FIG. 4D is a diagram illustrating an example oxygen generator according to various embodiments.

FIG. 4E is a diagram illustrating an example oxygen generator according to various embodiments.

FIG. 5 is a diagram illustrating a second mode of a multimodal oxygen control module according to various embodiments.

FIG. 6 is a diagram illustrating an example oxygen generator according to various embodiments.

FIG. 7 is a diagram illustrating an example multimodal oxygen control apparatus according to various embodiments.

FIG. 8 is a diagram illustrating a first mode of a multimodal oxygen control apparatus according to various embodiments.

FIG. 9 is a diagram illustrating a second mode of a multimodal oxygen control apparatus according to various embodiments.

FIG. 10 is a diagram illustrating a second mode of a multimodal oxygen control apparatus according to various embodiments.

FIG. 11 is a diagram illustrating a third mode of a multimodal oxygen control apparatus according to various embodiments.

FIG. 12 is a diagram illustrating a third mode of a multimodal oxygen control apparatus according to various embodiments.

FIG. 13 is a diagram illustrating a fourth mode of a multimodal oxygen control apparatus according to various embodiments.

FIG. 14 is a diagram illustrating a fifth mode of a multimodal oxygen control apparatus according to various embodiments.

FIG. 15 is a diagram illustrating a fifth mode of a multimodal oxygen control apparatus according to various embodiments.

### DETAILED DESCRIPTION

It should be appreciated that various example embodiments of the disclosure and the terms used for describing the various embodiments are not intended to limit the technological features set forth herein to particular embodiments, and include various changes, equivalents, or alternatives.

With regard to the description of the drawings, similar reference numerals may be used to refer to similar or related elements.

A singular form of a noun corresponding to an item may include one or more of the things, unless the relevant context clearly indicates otherwise.

As used herein, each of such phrases as "A or B," "at least one of A and B," "at least one of A or B," "A, B, or C," "at least one of A, B, and C," and "at least one of A, B, or C," may include any one of, or all possible combinations of the items enumerated together in a corresponding one of the phrases.

As used herein, the term "and/or" includes any one or a combination of a plurality of related recited elements.

As used herein, such terms as "1st" and "2nd," or "first" and "second" may be used to simply distinguish a corresponding component from another, and does not limit the components in any other respect (e.g., importance or order).

When an element (e.g., a first element) is referred to, with or without the term "operatively" or "communicatively", as being "coupled with," "coupled to," "connected with," or "connected to" another element (e.g., a second element), the element may be connected to the other element directly (e.g., in a wired manner), wirelessly, or via a third element.

As used herein, such terms as "comprises," "includes," or "has" specify the presence of stated features, numbers, stages, operations, components, parts, or a combination thereof, but do not preclude the presence or addition of one or more other features, numbers, stages, operations, components, parts, or a combination thereof.

When an element is referred to as being "connected to," "coupled to," "supported by," or "in contact with" another element, the element may be directly connected to, coupled to, supported by, or in contact with the other element, or the element may be indirectly connected to, coupled to, supported by, or in contact with the other element via a third element.

When an element is referred to as being "on" another element, does not require that the element be directly on another element, in other words, the element may be in contact with the other element, or still another element may be present between the element and the other element.

Hereinafter, a multimodal oxygen control module 1 and a multimodal oxygen control apparatus 20 according to an embodiment of the disclosure will be described in greater detail with reference to the accompanying drawings. Like reference numerals in the drawings indicate parts or elements that perform substantially the same functions.

As used herein, the term "oxygen" may refer to an oxygen molecule (O₂), which is formed by the bonding of two oxygen atoms (O), unless otherwise specified. The term "nitrogen" may refer to a nitrogen molecule (N₂), which is formed by the bonding of two nitrogen atoms (N), unless otherwise specified. The term "ozone" may refer to an ozone molecule (O₃), which is formed by the bonding of three oxygen atoms, unless otherwise specified.

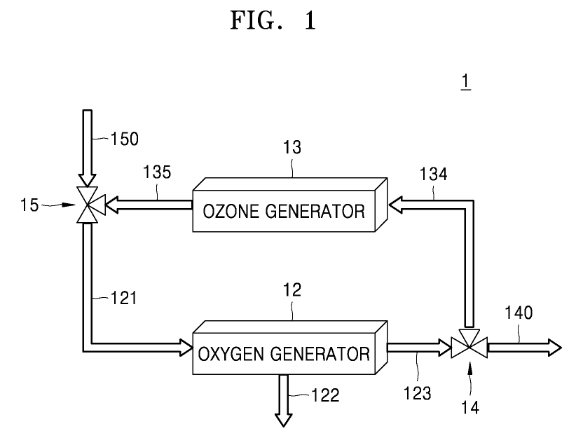

FIG. 1 is a diagram illustrating an example multimodal oxygen control module 1 according to various embodiments.

Referring to FIG. 1, a multimodal oxygen control module 1 according to an embodiment of the disclosure may be configured to separate and discharge oxygen from components of air introduced from an outside environment. The multimodal oxygen control module 1 may be provided to increase or decrease an oxygen concentration within a particular space. The multimodal oxygen control module 1 may be provided in medical devices, cleaning devices, food aging devices, and the like, but is not limited thereto.

The multimodal oxygen control module 1 according to an embodiment of the disclosure may include an oxygen generator 12. The oxygen generator 12 may be configured to discharge, as a second flow 122 and a third flow 123, air flowing in as a first flow 121. The oxygen generator 12 may be configured to separate oxygen from components of air. The separation of oxygen from components of air by the oxygen generator 12 may be achieved by discharging, as the second flow 122 and the third flow 123, the air flowing in as the first flow 121, but is not limited thereto. The first flow 121 may refer to a flow of air including oxygen, which flows into the oxygen generator 12. The oxygen generator 12 may discharge, as the third flow 123, oxygen from among the components of the air included in the first flow 121. In other words, the oxygen generator 12 may separate components other than oxygen (e.g., nitrogen) from the components of the air included in the first flow 121, and discharge the separated components as the second flow 122. However, the disclosure is not limited thereto, and for example, the oxygen generator 12 may discharge, as the second flow 122, oxygen from among the components of the air flowing in as the first flow 121, and discharge components other than oxygen as the third flow 123.

The oxygen generator 12 may, for example, be configured to separate oxygen from components of air using an electrochemical method. For example, the oxygen generator 12 may include an electrochemical cell configured to reduce oxygen atoms contained in moisture by applying a voltage to a cathode and an anode, but the disclosure is not limited thereto.

The oxygen generator 12 may be configured to separate oxygen from components of air using a difference in membrane permeation rates depending on the gas components. For example, the oxygen generator 12 may include a plurality of separation membranes, but is not limited thereto.

The oxygen generator 12 may be configured to separate oxygen from components of air using a difference in adsorption selectivity depending on the gas components. For example, the oxygen generator 12 may include a pressure swing adsorption (PSA) structure, but is not limited thereto. An example operation of the oxygen generator 12 including a PSA structure will be described below in greater detail.

The multimodal oxygen control module 1 according to an embodiment of the disclosure may selectively activate the oxygen generator 12. For example, the multimodal oxygen control module 1 may activate the oxygen generator 12 to separate oxygen from the components of the air flowing in as the first flow 121 into the second flow 122 and the third flow 123, or deactivate the oxygen generator 12 to discharge, as the second flow 122 or the third flow 123, the air flowing in as the first flow 121. When the multimodal oxygen control module 1 deactivates the oxygen generator 12, the oxygen generator 12 may not separate oxygen from the components of the air flowing in as the first flow 121.

The multimodal oxygen control module 1 according to an embodiment of the disclosure may include an intake flow path 150 and an exhaust flow path 140. The multimodal oxygen control module 1 may draw in air from the outside through the intake flow path 150. The air drawn in from the outside through the intake flow path 150 may flow into the oxygen generator 12 via the first flow 121 after passing through an intake node 15 that will be described in greater detail below. The multimodal oxygen control module 1 may discharge air to the outside through the exhaust flow path 140. The third flow 123, which is discharged from the oxygen generator 12, may be discharged to the outside through the exhaust flow path 140 after passing through an exhaust node 14 that will be described below.

The multimodal oxygen control module 1 according to an embodiment of the disclosure may include the exhaust node 14. The exhaust node 14 may provide a diversion point for the third flow 123 and may be in fluid communication with the outside. The third flow 123 may be diverted into the fourth flow 134 after passing through the exhaust node 14. The third flow 123 may be discharged to the outside through the exhaust flow path 140 after passing through the exhaust node 14. The exhaust node 14 being in fluid communication with the outside may refer, for example, to the third flow 123 being discharged to the outside through the exhaust flow path 140 after passing through the exhaust node 14. The exhaust node 14 may selectively block the flow of air to be diverted into the fourth flow 134. When the exhaust node 14 blocks the flow of air to be diverted into the fourth flow 134, the third flow 123 flowing into the exhaust node 14 may be discharged to the outside through the exhaust flow path 140. The exhaust node 14 may selectively block the flow of air to be diverted through the exhaust flow path 140. When the exhaust node 14 blocks the flow of air to be diverted through the exhaust flow path 140, the third flow 123 flowing into the exhaust node 14 may be diverted into the fourth flow 134. When the exhaust node 14 blocks the flow of air to be diverted through the exhaust flow path 140, the multimodal oxygen control module 1 may not discharge air to the outside.

The multimodal oxygen control module 1 according to an embodiment of the disclosure may include an ozone generator 13. The ozone generator 13 may convert oxygen from components of air into ozone. The fourth flow 134, which is diverted from the exhaust node 14, may flow into the ozone generator 13. The ozone generator 13 may be configured to discharge, as a fifth flow 135, air flowing in as the fourth flow 134. The ozone generator 13 may convert oxygen from components of the air, which flows in as the fourth flow 134, into ozone and discharge the ozone as the fifth flow 135. However, the disclosure is not limited thereto, and the ozone generator 13 may convert oxygen from components of air, which flows in through a path other than the fourth flow 134, into ozone and discharge the ozone as the fifth flow 135.

The ozone generator 13 may be configured to convert oxygen into ozone using a discharge method that applies a high voltage to an air flow. However, the disclosure is not limited thereto, and the ozone generator 13 may use various methods to convert oxygen into ozone, such as ultraviolet irradiation, electrolysis, or radiation exposure.

The multimodal oxygen control module 1 according to an embodiment of the disclosure may selectively activate the ozone generator 13. For example, the multimodal oxygen control module 1 may activate the ozone generator 13 to convert oxygen from the components of the air flowing in as the fourth flow 134 into ozone and discharge the ozone as the fifth flow 135, or deactivate the ozone generator 13 to discharge, as the fifth flow 135, the air flowing in as the fourth flow 134 without conversion.

The multimodal oxygen control module 1 according to an embodiment of the disclosure may include the intake node 15. The fifth flow 135, which is discharged by the ozone generator 13, may flow into the intake node 15. The intake node 15 may be in fluid communication with the outside. The intake node 15 being in fluid communication with the outside may refer, for example, to air drawn in from the outside through the intake flow path 150 flowing into the intake node 15. The intake node 15 may provide the first flow 121 to the oxygen generator 12. The intake node 15 may selectively block the flow of air drawn in through the intake flow path 150. When the intake node 15 blocks the flow of air drawn in through the intake flow path 150, the multimodal oxygen control module 1 may not draw in air from the outside.

Hereinafter, each mode of the multimodal oxygen control module 1, which selectively activates the oxygen generator 12 and the ozone generator 13, will be described in greater detail.

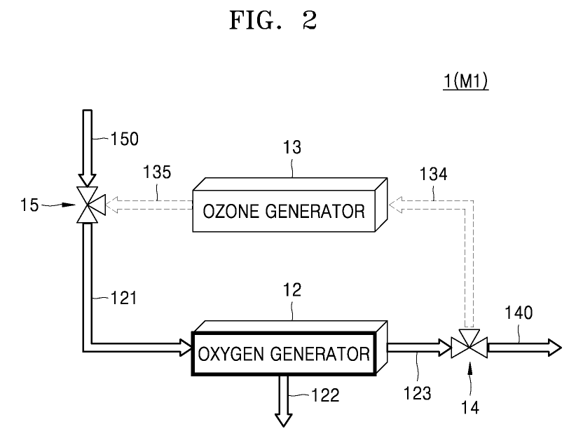

FIG. 2 is a diagram illustrating a first mode M1 of the multimodal oxygen control module 1 according to various embodiments.

Referring to FIGS. 1 and 2, the multimodal oxygen control module 1 according to an embodiment of the disclosure may have the first mode M1 that may be selectively activated. In the first mode M1, the multimodal oxygen control module 1 may activate the oxygen generator 12 to increase or decrease the oxygen concentration in the air discharged to the outside through the exhaust node 14. The air discharged to the outside through the exhaust node 14 may refer to the air discharged to the outside through the exhaust flow path 140 after passing through the exhaust node 14, but is not limited thereto. The multimodal oxygen control module 1 increasing or decreasing the oxygen concentration in the air discharged through the exhaust node 14 may refer, for example, to the concentration of oxygen discharged through the exhaust node 14 being higher or lower than that of the air flowing in from the outside through the intake node 15. The air flowing in from the outside through the intake node 15 may refer to the air flowing in from the outside through the intake flow path 150, but is not limited thereto.

When the multimodal oxygen control module 1 according to an embodiment of the disclosure operates in the first mode M1, the exhaust node 14 may block the flow of air to be diverted into the fourth flow 134. When the exhaust node 14 blocks the flow of air to be diverted into the fourth flow 134, the third flow 123 flowing into the exhaust node 14 may be discharged to the outside through the exhaust flow path 140. When the multimodal oxygen control module 1 operates in the first mode M1, the intake node 15 may not block the flow of air drawn in through the intake flow path 150. When the intake node 15 does not block the flow of air drawn in through the intake flow path 150, the multimodal oxygen control module 1 may draw in air from the outside.

In the first mode M1, the multimodal oxygen control module 1 according to an embodiment of the disclosure may form a circuit that is in fluid communication with the outside. In other words, in the first mode M1, the multimodal oxygen control module 1 may draw in air from the outside into the intake node 15 through the intake flow path 150, and may discharge air to the outside through the exhaust flow path 140 via the exhaust node 14. In the first mode M1, the multimodal oxygen control module 1 may provide the air drawn in from the outside, to the oxygen generator 12 through the first flow 121. In the first mode M1, the multimodal oxygen control module 1 may discharge air to the outside as the second flow 122. In the first mode M1, the multimodal oxygen control module 1 may discharge air to the outside as the third flow 123, which is discharged through the exhaust flow path 140 after passing through the exhaust node 14.

When the multimodal oxygen control module 1 according to an embodiment of the disclosure operates in the first mode M1 to increase the concentration of oxygen discharged to the outside through the exhaust node 14, the oxygen generator 12 may be activated to separate oxygen from components of the air flowing in as the first flow 121 and discharge the oxygen as the third flow 123. When the multimodal oxygen control module 1 operates in the first mode M1 to decrease the oxygen concentration in the air discharged to the outside through the exhaust node 14, the oxygen generator 12 may be activated to separate oxygen from components of the air flowing in as the first flow 121 and discharge the oxygen as the second flow 122.

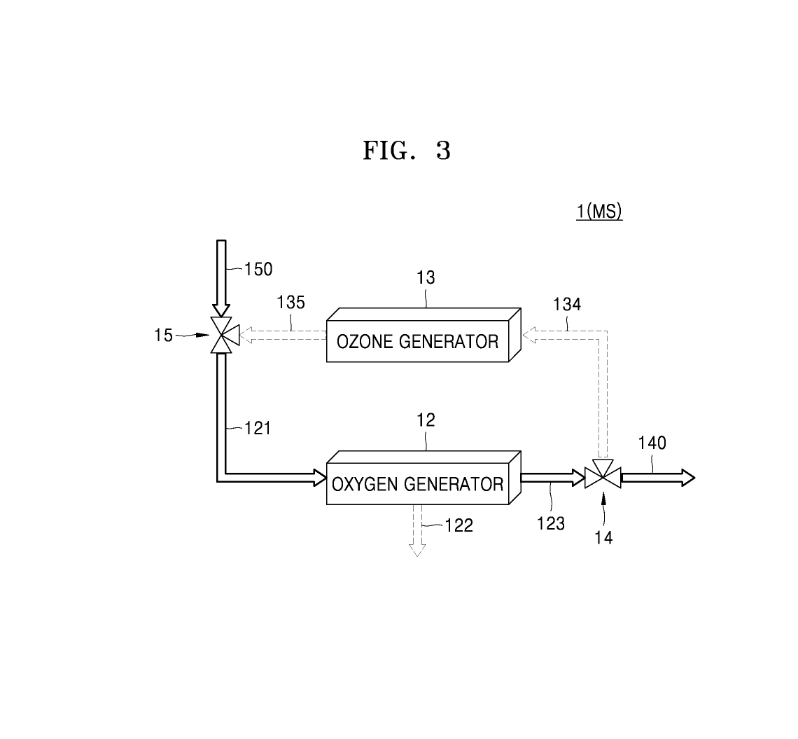

FIG. 3 is a diagram illustrating an example deodorization mode MS of the multimodal oxygen control module 1 according to various embodiments.

Referring to FIGS. 1 and 3, the multimodal oxygen control module 1 according to an embodiment of the disclosure may have the deodorization mode MS that may be selectively activated. The multimodal oxygen control module 1 operating in the deodorization mode MS may draw in air from the outside, remove odor-causing components (e.g., volatile organic compounds), and discharge the resulting air to the outside. In the deodorization mode MS, the multimodal oxygen control module 1 may deactivate the oxygen generator 12. The deactivation of the oxygen generator 12 by the multimodal oxygen control module 1 may refer, for example, to the air flowing into the oxygen generator 12 as the first flow 121 being discharged as the third flow 123, but is not limited thereto.

The oxygen generator 12 according to an embodiment of the disclosure may include an adsorbent. The oxygen generator 12 may adsorb odor-causing components from the air flowing in as the first flow 121, and discharge the resulting air as the third flow 123. The multimodal oxygen control module 1 may perform an air purification function by drawing in air from the outside, causing odor-causing components to be adsorbed by the adsorbent of the oxygen generator 12, and discharging the purified air.

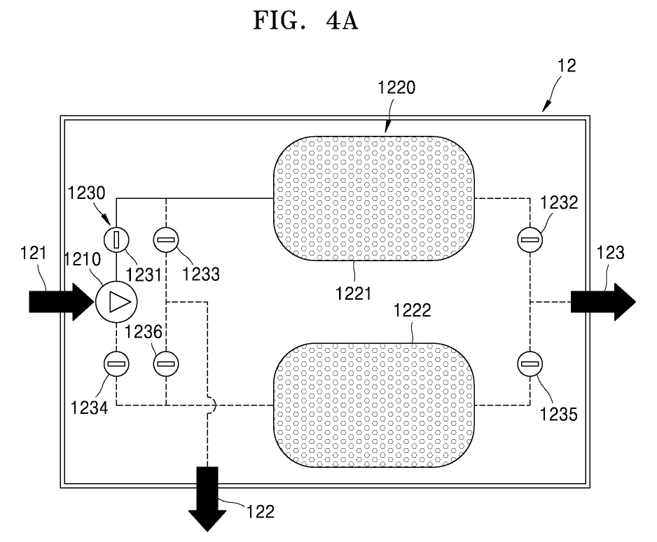

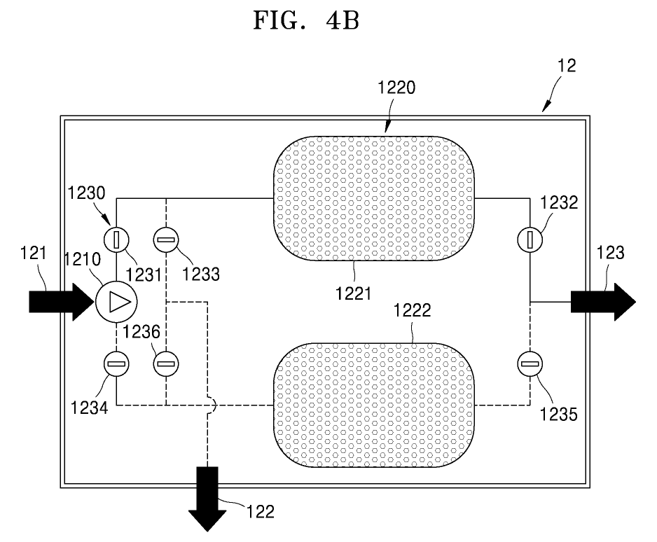

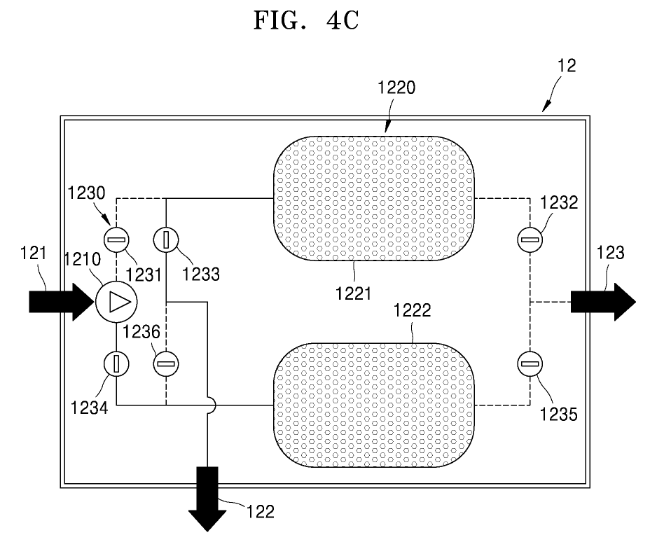

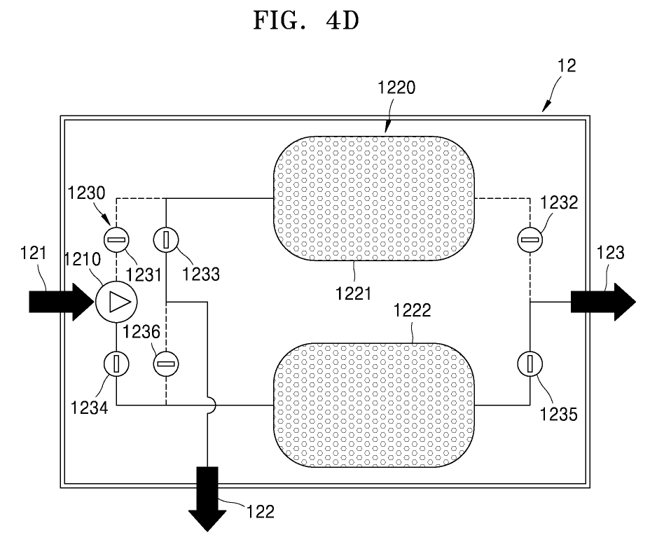

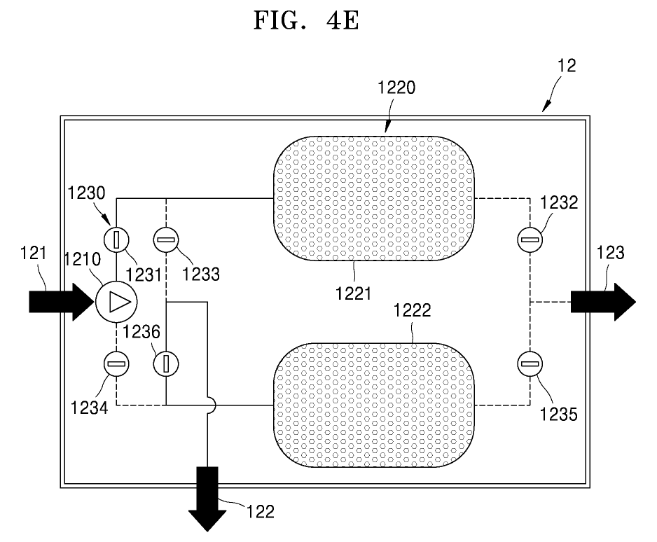

FIG. 4A is a diagram illustrating an example oxygen generator 12 according to various embodiments. FIG. 4B is a diagram illustrating an example oxygen generator 12 according to various embodiments. FIG. 4C is a diagram illustrating an example oxygen generator 12 according to various embodiments. FIG. 4D is a diagram illustrating an oxygen generator 12 according to various embodiments. FIG. 4E is a diagram illustrating an example oxygen generator 12 according to various embodiments. FIGS. 4A to 4E may illustrate respective states of the oxygen generator 12 operating in the first mode M1 of the multimodal oxygen control module 1. FIGS. 4A to 4E may illustrate respective states of the oxygen generator 12 operating in the first mode M1 of the multimodal oxygen control module 1 in chronological order. In addition, the oxygen generator 12 operating in the first mode M1 of the multimodal oxygen control module 1 may transition from the state illustrated in FIG. 4E to the state illustrated in FIG. 4A. In other words, the oxygen generator 12 operating in the first mode M1 of the multimodal oxygen control module 1 may cycle through the states of FIGS. 4A to 4E.

Referring to FIGS. 1, 2, and 4A to 4E, the oxygen generator 12 according to an embodiment of the disclosure may have a PSA structure. The oxygen generator 12 having the PSA structure may include a pressing unit 1210 and an adsorber 1220. The pressing unit 1210 may be configured to compress air flowing in as the first flow 121. The air compressed by the pressing unit 1210 inside the oxygen generator 12 may flow into the adsorber 1220. The adsorber 1220 may be configured to separate the components of air using a difference in the degree of adsorption depending on the components of the air. The adsorber 1220 may include an adsorbent (e.g., zeolite), but is not limited thereto.

The adsorber 1220 according to an embodiment of the disclosure may include a plurality of adsorption units. The adsorber 1220 may include a first adsorption unit 1221 and a second adsorption unit 1222. The first adsorption unit 1221 may be in fluid communication with the first flow 121. The second adsorption unit 1222 may be in fluid communication with the first flow 121. In other words, the air compressed by the pressing unit 1210 may independently flow into the first adsorption unit 1221 and the second adsorption unit 1222, respectively. The oxygen generator 12 may control the flow of air flowing therein.

The oxygen generator 12 according to an embodiment of the disclosure may include a plurality of flow paths including a plurality of diversion points. The plurality of flow paths inside the oxygen generator 12 may form a plurality of circuits through which air may flow. The plurality of circuits may be connected to the first flow 121, which flows into the oxygen generator 12. The plurality of circuits may be connected to the second flow 122, which is discharged by the oxygen generator 12. The plurality of circuits may be connected to the third flow 123, which is discharged by the oxygen generator 12. The plurality of circuits may be connected to the first adsorption unit 1221. The plurality of circuits may be connected to the second adsorption unit 1222.

The oxygen generator 12 according to an embodiment of the disclosure may include shut-off valves 1230 configured to control the flow of air flowing inside the oxygen generator 12. The shut-off valves 1230 may selectively block the flow of air flowing inside the oxygen generator 12. By the shut-off valves 1230 selectively blocking the flow of air flowing inside the oxygen generator 12, air may flow through a particular circuit among the plurality of circuits inside the oxygen generator 12.

The shut-off valves 1230 according to an embodiment of the disclosure may include a first shut-off valve 1231 to a sixth shut-off valve 1236. The first shut-off valve 1231 may selectively block a circuit connecting the first flow 121 to the first adsorption unit 1221. The second shut-off valve 1232 may selectively block a circuit connecting the first adsorption unit 1221 to the third flow 123. The third shut-off valve 1233 may selectively block a circuit connecting the first adsorption unit 1221 to the second flow 122. The fourth shut-off valve 1234 may selectively block a circuit connecting the first flow 121 to the second adsorption unit 1222. The fifth shut-off valve 1235 may selectively block a circuit connecting the second adsorption unit 1222 to the third flow 123. The sixth shut-off valve 1236 may selectively block a circuit connecting the second adsorption unit 1222 to the second flow 122.

Referring again to FIGS. 1, 2, and 4A, when the multimodal oxygen control module 1 according to an embodiment of the disclosure is in the the first mode M1, high-pressure air may flow into the first adsorption unit 1221 by opening the first shut-off valve 1231. The circuit connecting the first adsorption unit 1221 to the third flow 123 may be blocked by closing the second shut-off valve 1232. The circuit connecting the first adsorption unit 1221 to the second flow 122 may be blocked by closing the third shut-off valve 1233. The circuit connecting the first flow 121 to the second adsorption unit 1222 may be blocked by closing the fourth shut-off valve 1234.

Referring again to FIGS. 1, 2, 4A, and 4B, when the multimodal oxygen control module 1 according to an embodiment of the disclosure is in the first mode M1, oxygen from among components of air that has flowed into the first adsorption unit 1221 may be discharged as the third flow 123 by opening the second shut-off valve 1232. Components (e.g., nitrogen) other than oxygen among the components of the air that has flowed into the first adsorption unit 1221 may remain inside the first adsorption unit 1221, but the disclosure is not limited thereto.

Referring again to FIGS. 1, 2, 4B, and 4C, when the multimodal oxygen control module 1 according to an embodiment of the disclosure is in the first mode M1, components other than oxygen among the components of the air that has flowed into the first adsorption unit 1221 may be discharged as the second flow 122 by opening the third shut-off valve 1233. The circuit connecting the first adsorption unit 1221 to the third flow 123 may be blocked by closing the second shut-off valve 1232. High-pressure air may flow into the second adsorption unit 1222 by opening the fourth shut-off valve 1234, but the disclosure is not limited thereto.

Referring again to FIGS. 1, 2, 4C, and 4D, when the multimodal oxygen control module 1 according to an embodiment of the disclosure is in the first mode M1, oxygen from among components of air that has flowed into the second adsorption unit 1222 may be discharged as the third flow 123 by opening the fifth shut-off valve 1235. Components other than oxygen among the components of the air that has flowed into the second adsorption unit 1222 may remain inside the second adsorption unit 1222, but the disclosure is not limited thereto.

Referring again to FIGS. 1, 2, 4D, and 4E, when the multimodal oxygen control module 1 according to an embodiment of the disclosure is in the first mode M1, components other than oxygen among the components of the air that has flowed into the second adsorption unit 1222 may be discharged as the second flow 122 by opening the sixth shut-off valve 1236. The circuit connecting the second adsorption unit 1222 to the third flow 123 may be blocked by closing the fifth shut-off valve 1235. High-pressure air may flow into the first adsorption unit 1221 by opening the first shut-off valve 1231, but the disclosure is not limited thereto.

Referring again to FIGS. 1 to 4E, when the multimodal oxygen control module 1 according to an embodiment of the disclosure is in the first mode M1, a plurality of adsorption units included in the oxygen generator 12 may be alternately in fluid communication with the first flow 121. For example, in the first mode M1, when the first adsorption unit 1221 is in fluid communication with the first flow 121, the second adsorption unit 1222 may not be in fluid communication with the first flow 121. In the first mode M1, when the second adsorption unit 1222 is in fluid communication with the first flow 121, the first adsorption unit 1221 may not be in fluid communication with the first flow 121.

The performance of the oxygen generator 12 may degrade while the multimodal oxygen control module 1 operates in the first mode M1 or the deodorization mode MS. The degradation of the performance of the oxygen generator 12 may refer, for example, to the oxygen separation ability of the oxygen generator 12 being degraded, but is not limited thereto, and may also refer, for example, to an ability of the oxygen generator 12 to adsorb odor-causing components being degraded. The proliferation of microorganisms inside the oxygen generator 12 due to organic matter remaining therein may also be understood as a degradation of the performance of the oxygen generator 12. Performance degradation of the oxygen generator 12 may be caused by a polymer compound that is adsorbed by the adsorber 1220 in the oxygen generator 12 and remains without being discharged to the outside, but is not limited thereto. For example, in the oxygen generator 12 including a plurality of separation membranes, the proliferation of microorganisms between the separation membranes may cause degradation of the performance of the oxygen generator 12. When the performance of the oxygen generator 12 is degraded, it may be necessary to restore the performance of the oxygen generator 12 by regenerating the oxygen generator 12.

Hereinafter, the multimodal oxygen control module 1 configured to regenerate the oxygen generator 12 by selectively operating in a second mode M2 will be described in greater detail.

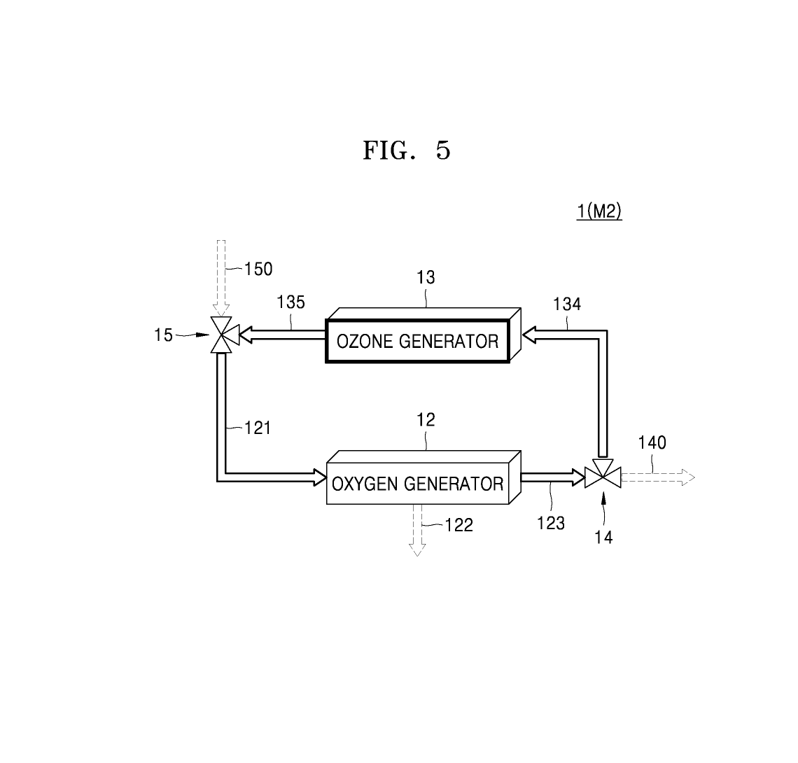

FIG. 5 is a diagram illustrating the second mode M2 of the multimodal oxygen control module 1 according to various embodiments.

Referring to FIGS. 1 to 5, the multimodal oxygen control module 1 according to an embodiment of the disclosure may have the second mode M2 that may be selectively activated. In the second mode M2 of the multimodal oxygen control module 1, the oxygen generator 12 may be regenerated by activating the ozone generator 13. Regenerating the oxygen generator 12 may refer to oxidizing organic matter accumulated inside the oxygen generator 12 using an ozone component flowing into the oxygen generator 12, but is not limited thereto.

When the multimodal oxygen control module 1 according to an embodiment of the disclosure operates in the second mode M2, the exhaust node 14 may block the flow of air discharged to the outside through the exhaust flow path 140. The exhaust node 14 may not block the flow of air to be diverted into the fourth flow 134. All of the third flow 123 flowing into the exhaust node 14 may be diverted into the fourth flow 134. In other words, the third flow 123 discharged by the oxygen generator 12 may be included in the fourth flow 134 by passing through the exhaust node 14 and flow into the ozone generator 13.

When the multimodal oxygen control module 1 according to an embodiment of the disclosure operates in the second mode M2, the ozone generator 13 may convert oxygen from components of air flowing in as the fourth flow 134 into ozone and discharge the ozone as the fifth flow 135. The fifth flow 135 may flow into the intake node 15.

When the multimodal oxygen control module 1 according to an embodiment of the disclosure operates in the second mode M2, the intake node 15 may block the flow of air drawn in from the outside through the intake flow path 150. The fifth flow 135 flowing into the intake node 15 may pass through the intake node 15 to be included in the first flow 121. The fifth flow 135 may be included in the first flow 121 by passing through the intake node 15 and flow into the oxygen generator 12.

When the multimodal oxygen control module 1 according to an embodiment of the disclosure operates in the second mode M2, the fifth flow 135 may include an ozone component. The ozone component included in the fifth flow 135 may be included in the first flow 121 by passing through the intake node 15 and flow into the oxygen generator 12. When the ozone component flows into the oxygen generator 12, the ozone component may regenerate the oxygen generator 12. The regeneration of the oxygen generator 12 may refer, for example, to the restoration of the degraded performance of the oxygen generator 12. For example, in a case in which the oxygen generator 12 includes a plurality of separation membranes, the regeneration of the oxygen generator 12 by the ozone component may refer to eliminating microorganisms that have proliferated between the separation membranes. For example, in a case in which the oxygen generator 12 has a PSA structure, the regeneration of the oxygen generator 12 by the ozone component may be the oxidation and discharge of a polymer compound (e.g., ethylene) adsorbed by the adsorber 1220 to the outside of the oxygen generator 12. However, the above descriptions of the method by which the ozone component regenerates the oxygen generator 12 are merely examples, and the disclosure is not limited thereto.

When the multimodal oxygen control module 1 according to an embodiment of the disclosure operates in the second mode M2, the exhaust node 14 may block the flow of air discharged to the outside through the exhaust flow path 140. The third flow 123 discharged by the oxygen generator 12 may be included in the fourth flow 134 by passing through the exhaust node 14 and flow into the ozone generator 13. The fourth flow 134, which has flowed into the ozone generator 13, may be included in the fifth flow 135 and flow into the intake node 15.

When the multimodal oxygen control module 1 according to an embodiment of the disclosure operates in the second mode M2, the intake node 15 may block the flow of air flowing in from the outside through the intake flow path 150. The fifth flow 135 discharged by the ozone generator 13 may be included in the first flow 121 by passing through the intake node 15 and flow into the oxygen generator 12. The first flow 121, which has flowed into the oxygen generator 12, may be included in the third flow 123 and flow into the exhaust node 14.

In the second mode M2, the multimodal oxygen control module 1 according to an embodiment of the disclosure may not form a circuit that is in fluid communication with the outside. In other words, the multimodal oxygen control module 1 may form a closed circuit. For example, a closed circuit through which the first flow 121, the third flow 123, the fourth flow 134, and the fifth flow 135 circulate may be formed within the multimodal oxygen control module 1. In the second mode M2, the multimodal oxygen control module 1 may form a closed circuit to prevent/reduce ozone components from leaking to the outside.

When the multimodal oxygen control module 1 according to an embodiment of the disclosure operates in the second mode M2, the air circulating through the closed circuit may include an ozone component at a predetermined concentration or higher. For example, the concentration of the ozone component in the air circulating through the closed circuit may be 200 ppb or higher. For example, the concentration of the ozone component in the air circulating through the closed circuit may be 400 ppb or higher. However, this is merely an example and the disclosure is not limited thereto.

The multimodal oxygen control module 1 according to an embodiment of the disclosure may operate in the second mode M2 for a predetermined period of time. Here, the predetermined period of time may refer to a period of time sufficient for air including an ozone component to regenerate the oxygen generator 12, but is not limited thereto. For example, the period of time for which the multimodal oxygen control module 1 circulates air including an ozone component through the closed circuit may be about 5 minutes to about 240 minutes. For example, the period of time for which the multimodal oxygen control module 1 circulates air including an ozone component through the closed circuit may be about 10 minutes to about 60 minutes. However, this is merely an example and the disclosure is not limited thereto.

The multimodal oxygen control module 1 according to an embodiment of the disclosure may have the first mode M1 and the second mode M2 that may be selectively activated. A user may selectively operate the multimodal oxygen control module 1 in a particular mode. For example, the user may increase or decrease an oxygen concentration in a surrounding environment by operating the multimodal oxygen control module 1 in the first mode M1. The user may regenerate the oxygen generator 12 by operating the multimodal oxygen control module 1 in the second mode M2. However, the method by which the multimodal oxygen control module 1 determines the operating mode is not limited thereto. For example, the multimodal oxygen control module 1 may regenerate the oxygen generator 12 by operating in the second mode M2 according to a determined time interval. For example, the multimodal oxygen control module 1 may determine the oxygen separation performance of the oxygen generator 12, and regenerate the oxygen generator 12 by operating in the second mode M2 when the performance of the oxygen generator 12 has degraded.

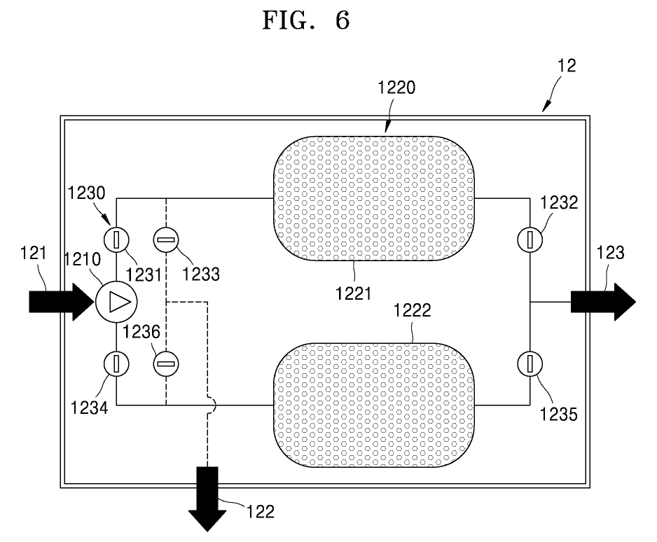

FIG. 6 is a diagram illustrating the oxygen generator 12 according to various embodiments. FIG. 6 may illustrate a state of the oxygen generator 12 in the second mode M2 of the multimodal oxygen control module 1.

Referring to FIGS. 1, 5, and 6, when the multimodal oxygen control module 1 according to an embodiment of the disclosure operates in the second mode M2, the oxygen generator 12 may deactivate the pressing unit 1210. In the second mode M2, the oxygen generator 12 may bring the first adsorption unit 1221 into fluid communication with the first flow 121. In the second mode M2, the oxygen generator 12 may bring the second adsorption unit 1222 into fluid communication with the first flow 121. In the second mode M2, the oxygen generator 12 may simultaneously bring the first adsorption unit 1221 and the second adsorption unit 1222 into fluid communication with the first flow 121. In other words, a plurality of adsorption units may all be in fluid communication with the first flow 121. When the multimodal oxygen control module 1 operates in the second mode M2, and the plurality of adsorption units are all in fluid communication with the first flow 121, the plurality of adsorption units may be regenerated simultaneously. When the multimodal oxygen control module 1 operates in the second mode M2, and the plurality of adsorption units are all in fluid communication with the first flow 121, noise generated by the oxygen generator 12 may not be significant.

Hereinafter, the multimodal oxygen control apparatus 20 configured to control the air composition inside a chamber 24 will be described. Redundant descriptions may not be repeated below, and the following description focuses on differences from the preceding descriptions.

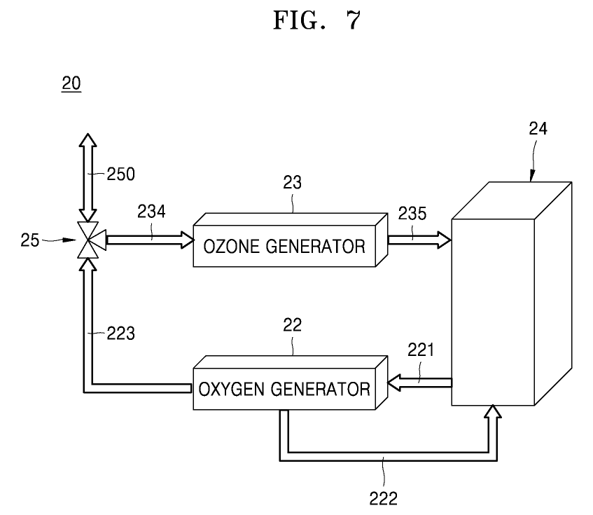

FIG. 7 is a diagram illustrating the multimodal oxygen control apparatus 20 according to various embodiments.

Referring to FIG. 7, the multimodal oxygen control apparatus 20 according to an embodiment of the disclosure may be configured to separate and discharge oxygen from components of air introduced from an outside environment. The multimodal oxygen control apparatus 20 may be provided to control the air composition inside a chamber 24. The multimodal oxygen control apparatus 20 may include a storage apparatus, a refrigerating apparatus, a food aging apparatus, and the like, but is not limited thereto.

The multimodal oxygen control apparatus 20 according to an embodiment of the disclosure may include an oxygen generator 22 and an ozone generator 23. Detailed configurations of the oxygen generator 22 and the ozone generator 23 may be the same as or similar to those described above.

The multimodal oxygen control apparatus 20 according to an embodiment of the disclosure may include a control node 25. The control node 25 may be in fluid communication with the outside. The control node 25 may include a control flow path 250. The control flow path 250 may be configured to draw in air from the outside or discharge air to the outside. The multimodal oxygen control apparatus 20 may draw in air from the outside through the control flow path 250. The multimodal oxygen control apparatus 20 may discharge air to the outside through the control flow path 250. The control flow path 250 may provide a path for exchanging air between an interior and an exterior of the multimodal oxygen control apparatus 20. The control flow path 250 may include a single flow path, but is not limited thereto, and may include a plurality of flow paths. For example, a path for the multimodal oxygen control apparatus 20 to draw in air from the outside and a path for the multimodal oxygen control apparatus 20 to discharge air to the outside may be provided separately.

The control node 25 according to an embodiment of the disclosure may provide a diversion point for a third flow 223. The third flow 223 may flow into the control node 25. The third flow 223 flowing into the control node 25 may be discharged to the outside through the control flow path 250. The third flow 223 flowing into the control node 25 may be diverted into a fourth flow 234. The control node 25 may selectively block the flow of air to be diverted into the fourth flow 234. When the control node 25 blocks the flow of air to be diverted into the fourth flow 234, all of the third flow 223 flowing into the control node 25 may be discharged to the outside. The control node 25 may selectively block the flow of air discharged to the outside through the control flow path 250. When the control node 25 blocks the flow of air discharged to the outside, all of the third flow 223 flowing into the control node 25 may be diverted into the fourth flow 234.

The control node 25 may selectively block the flow of air connected to the outside through the control flow path 250. When the control node 25 blocks the flow of air connected to the outside through the control flow path 250, all of the third flow 223 flowing into the control node 25 may be diverted into the fourth flow 234. When the control node 25 blocks the flow of air connected to the outside through the control flow path 250, the multimodal oxygen control apparatus 20 may not draw in air from the outside or discharge air to the outside.

The multimodal oxygen control apparatus 20 according to an embodiment of the disclosure may include the chamber 24. The chamber 24 may provide a first flow 221 to the oxygen generator 22. In other words, air extracted from an interior of the chamber 24 may be provided to the oxygen generator 22 as the first flow 221. A second flow 222 may flow into the chamber 24. In other words, the chamber 24 may receive the second flow 222 discharged by the oxygen generator 22. A fifth flow 235 may flow into the chamber 24. In other words, the chamber 24 may receive the fifth flow 235 discharged by the ozone generator 23. The first flow 221, the second flow 222, and the fifth flow 235 may be provided to control the air composition inside the chamber 24. For example, the air composition inside the chamber 24 may be controlled by regulating the components of the air that is provided to the chamber 24 via the second flow 222 and/or the fifth flow 235. For example, the air composition inside the chamber 24 may be controlled by extracting air from the interior of the chamber 24 via the first flow 221. However, this is merely an example and the disclosure is not limited thereto.

Hereinafter, each mode of the multimodal oxygen control apparatus 20, which selectively activates the oxygen generator 22 and the ozone generator 23, will be described in greater detail.

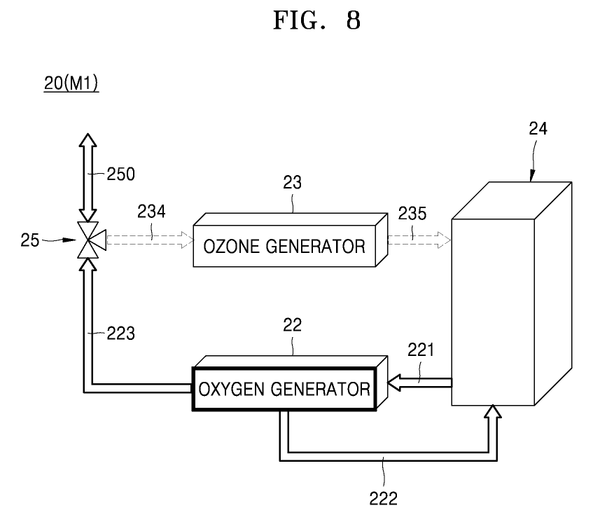

FIG. 8 is a diagram illustrating the first mode M1 of the multimodal oxygen control apparatus 20 according to various embodiments.

Referring to FIGS. 7 and 8, the multimodal oxygen control apparatus 20 according to an embodiment of the disclosure may have the first mode M1 that may be selectively activated. In the first mode M1, the multimodal oxygen control apparatus 20 may increase or decrease the oxygen concentration inside the chamber 24 by activating the oxygen generator 22. The multimodal oxygen control apparatus 20 increasing or decreasing the oxygen concentration inside the chamber 24 may refer, for example, to the oxygen concentration in the air provided to the chamber 24 via the second flow 222 and/or the fifth flow 235 being higher or lower than that of the air extracted from inside the chamber 24 via the first flow 221, but the disclosure is not limited thereto.

When the multimodal oxygen control apparatus 20 according to an embodiment of the disclosure operates in the first mode M1, the control node 25 may block the flow of air to be diverted into the fourth flow 234. When the control node 25 blocks the flow of air to be diverted into the fourth flow 234, the third flow 223 flowing into the control node 25 may be discharged to the outside through the control flow path 250. In the first mode M1, the multimodal oxygen control apparatus 20 may form a circuit that is in fluid communication with the outside.

When the multimodal oxygen control apparatus 20 according to an embodiment of the disclosure operates in the first mode M1 to increase the oxygen concentration in the chamber 24, the oxygen generator 22 may be activated to separate oxygen from components of the air flowing in as the first flow 221 and discharge the oxygen as the second flow 222. The oxygen concentration in the second flow 222 may be higher than that in the first flow 221. In the first mode M1, the multimodal oxygen control apparatus 20 may increase the oxygen concentration in the chamber 24 by supplying oxygen, which is separated as the second flow 222 from the air flowing into the oxygen generator 22 as the first flow 221, to the interior of the chamber 24.

When the multimodal oxygen control apparatus 20 according to an embodiment of the disclosure operates in the first mode M1 to decrease the oxygen concentration in the chamber 24, the oxygen generator 22 may be activated to separate oxygen from components of the air flowing in as the first flow 221 and discharge the oxygen as the third flow 223. The oxygen concentration in the third flow 223 may be higher than that in the first flow 221. The third flow 223 may be discharged to the outside through the control node 25. Conversely, the oxygen concentration in the second flow 222 may be lower than that in the first flow 221. The oxygen generator 22 may decrease the oxygen concentration in the chamber 24 by extracting the first flow 221 having a relatively high oxygen concentration from inside the chamber 24 and supplying the second flow 222 having a relatively low oxygen concentration to the interior of the chamber 24. In the first mode M1, the multimodal oxygen control apparatus 20 may decrease the oxygen concentration in the chamber 24 by discharging oxygen, which is separated as the third flow 223 from the air flowing into the oxygen generator 22 as the first flow 221, to the outside through the control node 25.

Referring again to FIGS. 4A to 4E, 7, and 8, the oxygen generator 22 of the multimodal oxygen control apparatus 20 according to an embodiment of the disclosure may have a PSA structure. The oxygen generator 22 may include a pressing unit configured to compress air flowing in as the first flow 221. The oxygen generator 22 may include an adsorber configured to separate components of air using a difference in the degree of adsorption depending on the air components. The adsorber may include a first adsorption unit and a second adsorption unit.

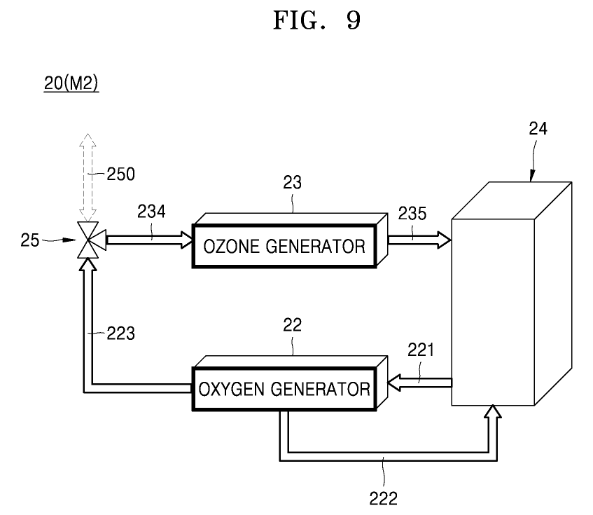

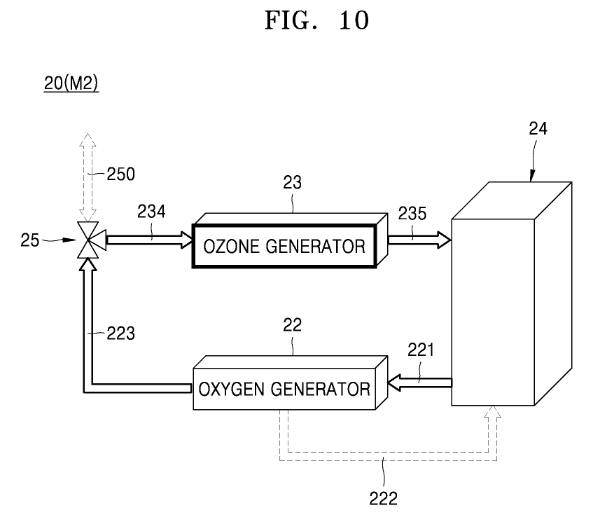

FIG. 9 is a diagram illustrating the second mode M2 of the multimodal oxygen control apparatus 20 according to various embodiments. FIG. 10 is a diagram illustrating the second mode M2 of the multimodal oxygen control apparatus 20 according to various embodiments.

Referring to FIGS. 7, 9, and 10, the multimodal oxygen control apparatus 20 according to an embodiment of the disclosure may have the second mode M2 that may be selectively activated. In the second mode M2, the multimodal oxygen control apparatus 20 may regenerate the oxygen generator 22 by activating the ozone generator 23. In the second mode M2 of the multimodal oxygen control apparatus 20, the oxygen generator 22 may be regenerated by activating the ozone generator 23. Regenerating the oxygen generator 22 may refer to oxidizing organic matter accumulated inside the oxygen generator 22 using an ozone component flowing into the oxygen generator 22, but is not limited thereto.

When the multimodal oxygen control apparatus 20 according to an embodiment of the disclosure is in the second mode M2, the control node 25 may block the flow of air that is discharged to, or flows in from, the outside through the control flow path 250. In other words, the third flow 223 discharged by the oxygen generator 22 may be included in the fourth flow 234 by passing through the control node 25 and flow into the ozone generator 23.

When the multimodal oxygen control apparatus 20 according to an embodiment of the disclosure is in the second mode M2, the ozone generator 23 may convert oxygen from components of the air flowing in as the fourth flow 234 into ozone and discharge the ozone as the fifth flow 235. The fifth flow 235 may flow into the chamber 24.

When the multimodal oxygen control apparatus 20 according to an embodiment of the disclosure is in the second mode M2, the fifth flow 235 may include an ozone component. The ozone component included in the fifth flow 235 may oxidize organic matter inside the chamber 24. For example, the ozone component included in the fifth flow 235 may eliminate microorganisms inside the chamber 24, but is not limited thereto. The ozone component inside the chamber 24 may be contained in the first flow 221 and flow into the oxygen generator 22. The first flow 221 extracted from inside the chamber 24 may include an ozone component. When the ozone component flows into the oxygen generator 22, the ozone component may regenerate the oxygen generator 22. The regeneration of the oxygen generator 22 may be the restoration of the degraded performance of the oxygen generator 22. For example, in a case in which the oxygen generator 22 includes a plurality of separation membranes, the regeneration of the oxygen generator 22 by the ozone component may refer to eliminating microorganisms that have proliferated between the separation membranes. For example, in a case in which the oxygen generator 22 has a PSA structure, the regeneration of the oxygen generator 22 by the ozone component may be the oxidation and discharge of a polymer compound (e.g., ethylene) adsorbed by an adsorber to the outside of the oxygen generator 22. However, the above descriptions of the method by which the ozone component regenerates the oxygen generator 22 is merely examples, and the disclosure is not limited thereto.

Referring again to FIG. 9, when the multimodal oxygen control apparatus 20 according to an embodiment of the disclosure is in the second mode M2, the oxygen generator 22 may separate oxygen from components of the air flowing in as the first flow 221 and discharge the oxygen as the third flow 223. In other words, when the multimodal oxygen control apparatus 20 is in the second mode M2, the oxygen generator 22 may be activated together with the ozone generator 23. The third flow 223 discharged by the oxygen generator 22 may be included in the fourth flow 234 and flow into the ozone generator 23. When the multimodal oxygen control apparatus 20 is in the second mode M2, the activation of the oxygen generator 22 may improve the efficiency of the ozone generator 23 in converting oxygen into ozone.

Referring again to FIGS. 6 and 10, when the multimodal oxygen control apparatus 20 according to an embodiment of the disclosure is in the second mode M2, the oxygen generator 22 may discharge the air flowing in as the first flow 221, as the third flow 223 without conversion. In other words, when the multimodal oxygen control apparatus 20 is in the second mode M2, the oxygen generator 22 may be deactivated. Here, in a case in which the oxygen generator 22 has a PSA structure, a plurality of adsorption units may all be in fluid communication with the first flow 221.

Referring again to FIGS. 9 and 10, in the second mode M2, the multimodal oxygen control apparatus 20 according to an embodiment of the disclosure may not form a circuit that is in fluid communication with the outside. The multimodal oxygen control apparatus 20 may block the control flow path 250 to prevent/reduce air exchange with the outside. In other words, the multimodal oxygen control apparatus 20 may form a closed circuit. For example, inside the multimodal oxygen control apparatus 20, the first flow 221 to the fifth flow 235 may be configured to circulate the air inside the chamber 24. In the second mode M2, the multimodal oxygen control apparatus 20 may form a closed circuit to prevent/reduce ozone components from leaking to the outside.

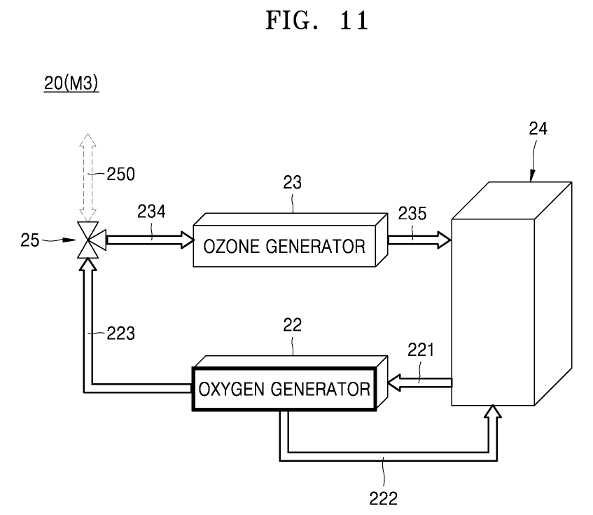

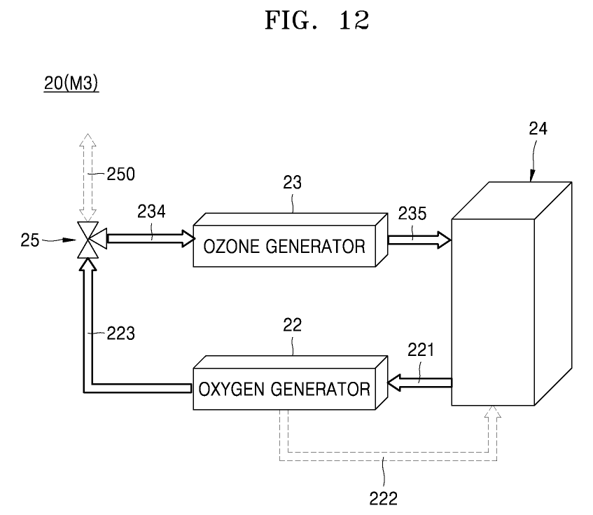

FIG. 11 is a diagram illustrating a third mode M3 of the multimodal oxygen control apparatus 20 according to various embodiments. FIG. 12 is a diagram illustrating the third mode M3 of the multimodal oxygen control apparatus 20 according to various embodiments.

Referring to FIGS. 11 and 12, the multimodal oxygen control apparatus 20 according to an embodiment of the disclosure may further have the third mode M3 that may be selectively activated. In the third mode M3, the multimodal oxygen control apparatus 20 may decrease an ozone concentration inside the chamber 24. The multimodal oxygen control apparatus 20 may extract the first flow 221, which includes an ozone component, from inside the chamber 24. The oxygen generator 22 may convert the ozone component included in the first flow 221 into oxygen. For example, in a case in which the oxygen generator 22 includes an adsorbent, the ozone

component may be reduced to oxygen through a catalytic action of the adsorbent. However, the above description of the method by which the oxygen generator 22 converts an ozone component into oxygen is merely an example, and the disclosure is not limited thereto.

In the third mode M3, the multimodal oxygen control apparatus 20 according to an embodiment of the disclosure may block the control flow path 250. In the third mode M3, the multimodal oxygen control apparatus 20 may not exchange air with the outside. The multimodal oxygen control apparatus 20 may not discharge an intermediate product (e.g., methanol), which may be present during the process of converting ozone into oxygen, to the outside.

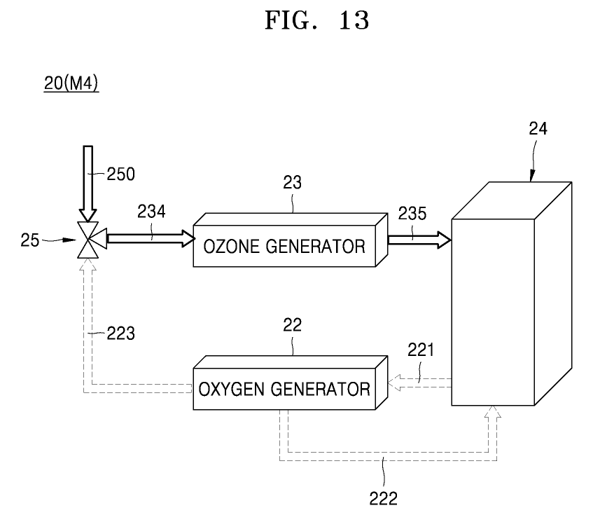

FIG. 13 is a diagram illustrating a fourth mode M4 of the multimodal oxygen control apparatus 20 according to various embodiments.

Referring to FIG. 13, the multimodal oxygen control apparatus 20 according to an embodiment of the disclosure may further have the fourth mode M4 that may be selectively activated. In the fourth mode M4, the multimodal oxygen control apparatus 20 may increase the pressure inside the chamber 24. In the fourth mode M4, the multimodal oxygen control apparatus 20 may draw in air from the outside through the control flow path 250. In the fourth mode M4, the multimodal oxygen control apparatus 20 may supply air, which is introduced from the outside through the control flow path 250, to the interior of the chamber 24 as the fifth flow 235. The oxygen generator 22 may not extract the air inside the chamber 24 as the first flow 221. For example, the fourth mode M4 may be activated when the pressure inside the chamber 24 decreases excessively as the multimodal oxygen control apparatus 20 in the first mode M1 discharges air to the outside, but is not limited thereto.

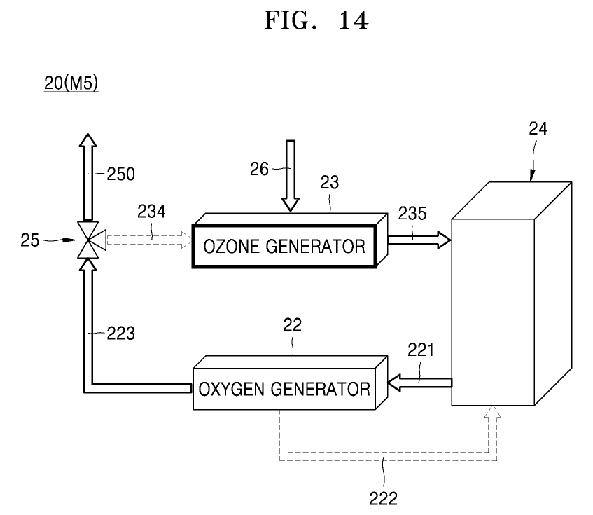

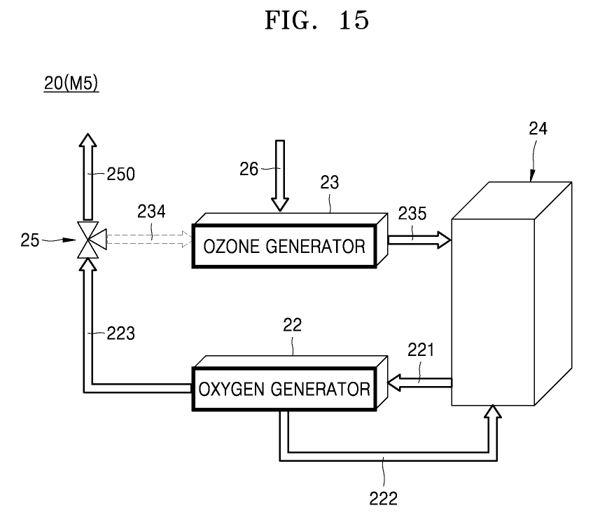

FIG. 14 is a diagram illustrating a fifth mode M5 of the multimodal oxygen control apparatus 20 according to various embodiments. FIG. 15 is a diagram illustrating the fifth mode M5 of the multimodal oxygen control apparatus 20 according to various embodiments.

Referring to FIGS. 14 and 15, the multimodal oxygen control apparatus 20 according to an embodiment of the disclosure may further include a bypass flow path 26. The bypass flow path 26 may be configured to draw in air from the outside and direct it to flow into the ozone generator 23. The bypass flow path 26 may be a component that is separate from the control flow path 250. The bypass flow path 26 may allow air to flow into the ozone generator 23 without passing through the control node 25.

The multimodal oxygen control apparatus 20 according to an embodiment of the disclosure may further have the fifth mode M5 that may be selectively activated. In the fifth mode M5, the multimodal oxygen control apparatus 20 may oxidize organic matter inside the chamber 24. Oxidizing the organic matter inside the chamber 24 may refer to eliminating microorganisms inside the chamber 24, but is not limited thereto. In the fifth mode M5, the multimodal oxygen control apparatus 20 may convert oxygen from components of the air, which flows into the ozone generator 23 through the bypass flow path 26, into ozone and provide the ozone to the chamber 24. For example, the ozone generator 23 may convert oxygen from components of the air flowing in as a sixth flow into ozone and provide the ozone to the chamber 24 through the fifth flow 235.

Referring again to FIG. 14, in the fifth mode M5, the multimodal oxygen control apparatus 20 according to an embodiment of the disclosure may discharge air to the outside through the control flow path 250. The control node 25 may block the flow of air to be diverted into the fourth flow 234. In the fifth mode M5, the multimodal oxygen control apparatus 20 may control the pressure inside the chamber 24 to be constant by discharging air to the outside through the control flow path 250.

Referring again to FIG. 15, in the fifth mode M5, the multimodal oxygen control apparatus 20 according to an embodiment of the disclosure may activate the oxygen generator 22 to separate oxygen from the air flowing in as the first flow 221 from inside the chamber 24. In the fifth mode M5, the multimodal oxygen control apparatus 20 may discharge air to the outside through the control flow path 250. The control node 25 may block the flow of air to be diverted into the fourth flow 234. When oxygen separated by the oxygen generator 22 from the first flow 221 is discharged to the outside through the control node 25 via the third flow 223, the oxygen concentration inside the chamber 24 may decrease. When oxygen separated by the oxygen generator 22 from the first flow 221 flows into the chamber 24 through the second flow 222, the oxygen concentration inside the chamber 24 may increase. In the fifth mode M5, the multimodal oxygen control apparatus 20 may simultaneously oxidize organic matter inside the chamber 24 and control the oxygen concentration inside the chamber 24, by simultaneously activating the ozone generator 23 and the oxygen generator 22.

A multimodal oxygen control module according to an example embodiment of the disclosure may include an oxygen generator configured to separate oxygen from components of air by discharging, as a second flow and a third flow, air flowing in as a first flow, an exhaust node

configured to provide a diversion point for the third flow and to be in fluid communication with the outside, an ozone generator into which a fourth flow diverted from the exhaust node flows, the ozone generator being configured to convert oxygen from components of incoming air into ozone and to discharge the ozone as a fifth flow, and an intake node into which the fifth flow flows, the intake node being configured to be in fluid communication with the outside and to provide the first flow to the oxygen generator, wherein an ozone component included in the fifth flow is included in the first flow by passing through the intake node and flows into the oxygen generator to regenerate the oxygen generator.

The multimodal oxygen control module may have a first mode and a second mode that are selectively activated, wherein, in the first mode, the oxygen generator may be activated to increase or decrease an oxygen concentration in air discharged to the outside through the exhaust node, and in the second mode, the ozone generator may be activated to cause the ozone component flowing into the oxygen generator to oxidize organic matter accumulated inside the oxygen generator.

In the second mode, a closed circuit through which the first flow, the third flow, the fourth flow, and the fifth flow circulate may be formed to prevent/reduce the ozone component from leaking to the outside.

The oxygen generator may include a PSA structure including a pressing unit including a compressor configured to compress air flowing in as the first flow and an adsorber configured to separate components of air using a difference in a degree of adsorption depending on the components of the air.

The adsorber of the oxygen generator may include a plurality of adsorption units that are alternately in fluid communication with the first flow in the first mode, and in the second mode, the plurality of adsorption units may all be in fluid communication with the first flow.

In the second mode, a period of time for which air including the ozone component is circulated through the closed circuit may be about 5 minutes to about 240 minutes.

In the second mode, a concentration of the ozone component in the air circulating through the closed circuit may be 200 ppb or higher.

A multimodal oxygen control apparatus according to an example embodiment of the disclosure may include an oxygen generator configured to separate oxygen from components of air by discharging, as a second flow and a third flow, air flowing in as a first flow, a chamber that is configured to provide the first flow to the oxygen generator, and into which the second flow flows, a control node including a control flow path configured to draw in air from the outside or discharge air to the outside, the control node being configured to provide a diversion point for the third flow, and an ozone generator into which a fourth flow diverted from the control node flows, the ozone generator being configured to convert oxygen from components of incoming air into ozone and to discharge the ozone as a fifth flow that flows into the chamber, wherein an ozone component included in the fifth flow is included in the first flow by passing through the chamber and flows into the oxygen generator to regenerate the oxygen generator.

The multimodal oxygen control apparatus may have a first mode and a second mode that are selectively activated, wherein in the first mode, the oxygen generator may be activated to increase or decrease an oxygen concentration inside the chamber, and in the second mode, the ozone generator may be activated to cause the ozone component flowing into the oxygen generator to oxidize organic matter accumulated inside the oxygen generator.

In the first mode, the oxygen concentration inside the chamber may be increased by supplying, to an interior of the chamber, oxygen that is separated as the second flow from the air flowing into the oxygen generator as the first flow, or the oxygen concentration inside the chamber may be decreased by discharging, to the outside through the control node, oxygen that is separated as the third flow from the air flowing into the oxygen generator as the first flow.

In the second mode, the control flow path may be blocked to prevent/reduce the ozone component from leaking to the outside.

The oxygen generator may include a PSA structure including a pressing unit including a compressor configured to compress air flowing in as the first flow and an adsorber configured to separate components of air using a difference in a degree of adsorption depending on the components of the air.

The multimodal oxygen control apparatus may further have a third mode that is selectively activated, and in the third mode, the control flow path may be blocked and the oxygen generator converts the ozone component included in the first flow into oxygen to decrease a concentration of the ozone component inside the chamber.

The multimodal oxygen control apparatus may further have a fourth mode that is selectively activated, and in the fourth mode, air introduced from the outside through the control

flow path may be supplied to the interior of the chamber as the fifth flow to increase a pressure inside the chamber.

The multimodal oxygen control apparatus may further include a bypass flow path configured to draw in air from the outside and direct the air to flow into the ozone generator, and may further have a fifth mode that is selectively activated, and in the fifth mode, organic matter inside the chamber may be oxidized by converting oxygen from components of the air, which flows into the ozone generator through the bypass flow path, into ozone and providing the ozone to the chamber.

The above-described embodiments of the disclosure are merely examples, and those skilled in the art will appreciate that various modifications are possible therefrom. Therefore, the true technical protection scope according to an embodiment of the disclosure should be determined by the technical of the disclosure, including the following claims. It will also be understood that any of the embodiment(s) described herein may be used in conjunction with any other embodiment(s) described herein.

What is claimed is:

1. A multimodal oxygen control module comprising:
an oxygen generator configured to separate oxygen from components of air by discharging, as a second flow and a third flow, air flowing in as a first flow;
an exhaust node configured to provide a diversion point for the third flow and in fluid communication with outside;
an ozone generator configured to receive a fourth flow diverted from the exhaust node, the ozone generator (13) being configured to convert oxygen from components of incoming air into ozone and to discharge the ozone as a fifth flow; and
an intake node configured to receive the fifth flow, the intake node being in fluid communication with the outside and configured to provide the first flow to the oxygen generator,
wherein an ozone component included in the fifth flow is included in the first flow passing through the intake node and is configured to flow into the oxygen generator to regenerate the oxygen generator.

2. The multimodal oxygen control module of claim 1, wherein the multimodal oxygen control module is configured to operate in a first mode and a second mode configured to be selectively activated, wherein:
in the first mode, the oxygen generator is configured to be activated to increase or decrease an oxygen concentration in air discharged to the outside through the exhaust node, and
in the second mode, the ozone generator is configured to be activated to cause the ozone component flowing into the oxygen generator to oxidize organic matter accumulated inside the oxygen generator.

3. The multimodal oxygen control module of claim 2, wherein, in the second mode, a closed circuit through which the first flow, the third flow, the fourth flow, and the fifth flow are configured to circulate is formed to reduce the ozone component from leaking to the outside.

4. The multimodal oxygen control module of claim 2, wherein the oxygen generator comprises a pressure swing adsorption (PSA) structure comprising a pressing unit including a compressor configured to compress air flowing in as the first flow and an adsorber configured to separate components of air using a difference in a degree of adsorption depending on the components of the air.

5. The multimodal oxygen control module of claim 4, wherein the adsorber of the oxygen generator comprises a plurality of adsorption units, each including an adsorber, that are alternately in fluid communication with the first flow in the first mode, and
in the second mode, the plurality of adsorption units are in fluid communication with the first flow.

6. The multimodal oxygen control module of claim 4, wherein, in the second mode, a period of time for which air including the ozone component is circulated through the closed circuit is in a range of about 5 minutes to about 240 minutes.

7. The multimodal oxygen control module of claim 4, wherein, in the second mode, a concentration of the ozone component in the air circulating through the closed circuit is 200 ppb or higher.

8. A multimodal oxygen control apparatus comprising:
an oxygen generator configured to separate oxygen from components of air by discharging, as a second flow and a third flow, air flowing in as a first flow;
a chamber configured to provide the first flow to the oxygen generator, and to receive the second flow;
a control node comprising a control flow path configured to draw in air from outside or discharge air to the outside, the control node being configured to provide a diversion point for the third flow; and
an ozone generator configured to receive a fourth flow diverted from the control node, the ozone generator being configured to convert oxygen from components of incoming air into ozone and to discharge the ozone as a fifth flow into the chamber,
wherein an ozone component included in the fifth flow is included in the first flow passing through the chamber and is configured to flow into the oxygen generator to regenerate the oxygen generator.

9. The multimodal oxygen control apparatus of claim 8, wherein the multimodal oxygen control apparatus is configured to operate in a first mode and a second mode and is configured to be selectively activated, wherein:
in the first mode, the oxygen generator is activated to increase or decrease an oxygen concentration inside the chamber, and
in the second mode, the ozone generator is activated to cause the ozone component flowing into the oxygen generator to oxidize organic matter accumulated inside the oxygen generator.

10. The multimodal oxygen control apparatus of claim 9, wherein, in the first mode, the oxygen concentration inside the chamber is increased by supplying, to an interior of the chamber, oxygen separated as the second flow from the air flowing into the oxygen generator as the first flow, or the oxygen concentration inside the chamber is decreased by discharging, to the outside through the control node, oxygen separated as the third flow from the air flowing into the oxygen generator as the first flow.

11. The multimodal oxygen control apparatus of claim 10, wherein, in the second mode, the control flow path is blocked to reduce the ozone component from leaking to the outside.

12. The multimodal oxygen control apparatus of claim 10, wherein the oxygen generator comprises a pressure swing adsorption (PSA) structure comprising a pressing unit including a compressor configured to compress air flowing in as the first flow and an adsorber configured to separate components of air using a difference in a degree of adsorption depending on the components of the air.

13. The multimodal oxygen control apparatus of claim 12, wherein the multimodal oxygen control apparatus further includes a third mode configured to be selectively activated, and
in the third mode, the control flow path is blocked and the oxygen generator converts the ozone component included in the first flow into oxygen to decrease a concentration of the ozone component inside the chamber.

14. The multimodal oxygen control apparatus of claim 10, wherein the multimodal oxygen control apparatus further includes a fourth mode configured to be selectively activated, and
in the fourth mode, air introduced from the outside through the control flow path is supplied to the interior of the chamber as the fifth flow to increase a pressure inside the chamber.

15. The multimodal oxygen control apparatus of claim 10, further comprising a bypass flow path configured to draw in air from the outside and direct the air to flow into the ozone generator,
wherein the multimodal oxygen control apparatus includes a fifth mode configured to be selectively activated, and
in the fifth mode, organic matter inside the chamber is oxidized by converting oxygen from components of the air, which flows into the ozone generator \through the bypass flow path, into ozone and providing the ozone to the chamber.
